(19) United States
(12) Patent Application Publication
(10) Pub. No.: US 2021/0365338 A1
(43) Pub. Date: Nov. 25, 2021

(54) COMPUTER-IMPLEMENTED METHOD FOR TESTING A TECHNICAL SYSTEM

(71) Applicant: Robert Bosch GmbH, Stuttgart (DE)

(72) Inventors: Peter Bakucz, Klosterlechfeld (DE); Javier Bores, Vaihingen-Kleinglattbach (DE)

(21) Appl. No.: 17/183,583

(22) Filed: Feb. 24, 2021

(30) Foreign Application Priority Data
May 20, 2020 (DE) 102020206325.7

(51) Int. Cl. G06F 11/26; G06N 7/02

(52) U.S. Cl. CPC G06F 11/26; G06N 7/02

(57) ABSTRACT

A computer-implemented method for testing a technical system, in particular software, hardware, or an embedded system, in real time. The technical system encompasses a plurality of in particular technical components. The technical system is represented by a fuzzy fault tree topology Aₖᵢ. Starting from a fuzzy top event Xₖ for determining priorities of base events, the following steps are carried out: providing a fuzzy membership function matrix Wᵢ^{λ} of the base events, where λ=1, and carrying out an iterative process, each iteration λ, where λ=1, 2, 3, . . . , n, encompassing the following steps: determining an auxiliary matrix Cₖᵢ, taking into account the fuzzy top event Xₖ, the fuzzy fault tree topology A_{id}, and the fuzzy membership function matrix Wᵢ^{λ}, using an iterative algorithm, and determining (the fuzzy membership function matrix Wᵢ^{λ+1} based on the auxiliary matrix Cₖᵢ, using a maximum likelihood method.

### CROSS REFERENCE

The present application claims the benefit under 35 U.S.C. § 119 of German Patent Application No. DE 102020206325.7 filed on May 20, 2020, which is expressly incorporated herein by reference in its entirety.

### BACKGROUND INFORMATION

Fault tree analysis (FTA) is a conventional method for analyzing the error logic of a system and for computing the overall reliability.

Fault tree analysis is based on a single undesirable event situated at the top of the fault tree, the so-called top event, which for example describes the total failure of the system and which is ascertained within the scope of a hazard analysis.

Starting from this top event, the fault tree is created in a top-down analysis, all the way down to the individual failure states of the components. For more complex systems, a subdivision takes place into subsystems, which are analogously further subdivided until the entire system is mapped in the form of minimum sections, in the form of base events, that are no longer subdividable. The failure combinations in the fault tree are logically linked using Boolean algebra and its symbols, in particular AND and OR.

In the simplest case, components of a system having an interdependent functionality are linked by the logical OR function. In this case, the failure even of one component results in a failure of the entire system. Components that may be reciprocally replaced in the function (redundancy) are linked by the AND function in the fault tree.

In conventional fault tree analysis, the likelihoods of failure are regarded as an exact value, i.e., as an individual estimated value or a fixed value. However, it may sometimes be difficult to estimate an exact failure rate of the components when, for example, insufficient data, or indeterminate characteristics of the events, are present. This may be of crucial importance in particular in the design phase, when the details of the components are possibly not yet established, and therefore an exact failure rate is not known.

### SUMMARY

The present invention relates to a computer-implemented method for testing a technical system in real time, in particular software, hardware, or an embedded system, the technical system encompassing a plurality of in particular technical components, and the technical system being represented by a fuzzy fault tree topology Aₖᵢ where k=1 and i=1, . . . , (n*n−n)/2, and starting from a fuzzy top event Xₖ for determining priorities of base events, the following steps are carried out:

providing a fuzzy membership function matrix Wᵢ^{λ} of the base events, where λ=1, and carrying out an iterative process, each iteration λ, where λ=1, 2, 3, . . . , n, encompassing the following steps:

determining an auxiliary matrix Cₖᵢ, taking into account fuzzy top event Xₖ, fuzzy fault tree topology Aₖᵢ, and fuzzy membership function matrix Wᵢ^{λ}, using an iterative algorithm, and determining fuzzy membership function matrix Wᵢ^{λ+1} based on auxiliary matrix Cₖᵢ, using a maximum likelihood method.

By use of the fuzzy membership function of the base events, in particular a fuzziness of the occurrence of the base events may be gradually indicated via numerical values between 0 and 1. The membership functions in particular have a trapezoidal or triangular shape. However, the membership functions may also have other shapes.

This plays a role due to the fact that insufficient data often make it difficult to objectively determine the likelihood. Therefore, human assessments using linguistic variables are indispensable. For example, linguistic terms such as “very low, low, high, and fairly high” are used to describe the likelihood of events. Diagnostic methods are based, for example, on observed analytical, heuristic symptoms and the heuristic knowledge concerning the process. These include, for example, observations obtained, for example, by inspection by operating personnel in various forms, for example via acoustic sounds such as vibrations, or visual impressions such as colors or smoke. However, indeterminate symptoms frequently occur which may usually be expressed only in the form of qualitative measures or linguistic variables such as “few,” “average,” or “many.” In fact, conventional mathematical methods, due to their indeterminate nature, cannot efficiently deal with natural linguistic expressions.

The conventional fault tree analysis is static, not real-time capable, not programmable, and the priorities of the base events are not unambiguous.

The method in accordance with an example embodiment of the present invention may overcome the limitations of conventional fault tree analysis via embedded real-time determination and application of fuzzy logic.

Via the embedded real-time determination of the priorities of the fuzzy base events, based on fuzzy fault tree topology using the iterative embedded optimization method, starting from the fuzzy top event, it is advantageously possible to take into account the real, system-related fuzzy membership functions of the base events. In addition, it is possible to determine the priorities of the fuzzy base events. Furthermore, it is possible to monitor the changes in the fuzzy membership functions of the base events online, i.e., in real time during operation of the technical system.

For the components of the technical system, via the priorities of the base events an analysis may be made concerning to what extent the component is important or critical for the safety or the risk of failure of the technical system. Based on the analysis, the technical system may advantageously be adapted to reduce the likelihood of failure or to increase product safety.

The example method may be used even during the development of technical systems, in particular for designing the components. In addition, the method may be used during operation of technical systems. For example, safety-relevant decisions may then be made as a function of the ascertained priorities.

According to one specific embodiment of the present invention, it is provided that the priority of the base events is derived from the difference between the elements of fuzzy membership function matrix Wᵢ¹ and the elements of fuzzy membership function matrix Wᵢ^{λ+1}. Iteration λ+1 is advantageously the last iteration of the iterative process. Thus, fuzzy membership function matrix Wᵢ^{λ+1} is the last matrix computed using the iterative process. Fuzzy membership function matrix Wᵢ^{λ+1} is then compared to original fuzzy membership function matrix Wᵢ¹, and the priority of the base events is derived based on the difference between the two matrices. For the two matrices, namely, fuzzy membership function matrix Wᵢ¹ and fuzzy membership function matrix Wᵢ^{λ+1}, the metric distance between the lines is advantageously compared for each line. The base event with the greatest difference is advantageously the base event having the highest priority. The base event with the smallest difference is advantageously the base event having the lowest priority.

According to one specific embodiment of the present invention, it is provided that the provision of fuzzy membership function matrix Wᵢ^{λ}, where λ=1, takes place by assigning instantaneous values, in particular states and/or measuring results of the technical system.

According to one specific embodiment of the present invention, it is provided that after a time period elapses, a fuzzy membership function matrix Wᵢ^{λ} of the base events, where λ=1, is again provided, and the iterative process is carried out again based on instantaneous fuzzy membership function matrix Wᵢ^{λ} of the base events, where λ=1. In this way, an instantaneous membership function may be assigned to the base events at any time. The new provision of fuzzy membership function matrix Wᵢ^{λ} takes place, for example, by providing a value table encompassing, for example, values and/or states of components of the technical system. The value table includes, for example for a certain time period, values and/or states of the components at various points in time. In addition, the provision of fuzzy membership function matrix Wᵢ^{λ} may also take place by again measuring values and/or states of components of the technical system.

According to one specific embodiment of the present invention, it is provided that auxiliary matrix Cₖᵢ is determined iteratively via the following equation:

$${C}_{ki} = \frac{{W}_{i}^{λ} {X}_{k} {A}_{ki}}{{r}_{k}}$$

where i=1, 2, . . . n,
and

$${r}_{k} = {\sum }_{i = k}^{n} {A}_{ki} {W}_{i}^{λ}$$

applies and Wᵢ^{λ} represents the instantaneous estimate of the fuzzy membership functions, Xₖ represents the fuzzy top event, and Aₖᵢ represents the fuzzy fault tree topology.

According to one specific embodiment of the present invention, it is provided that fuzzy membership function matrix Wᵢ^{λ+1} is determined via

$${W}_{i}^{λ + 1} = \frac{1}{{q}_{i}} {\sum }_{k = 1}^{i} {C}_{ki}$$

where the following applies:

$${q}_{i} = {\sum }_{k = 1}^{i} {A}_{ki}$$

The iterative algorithm requires comparatively little computing time, and thus allows embedded real-time microcontroller applications.

According to one specific embodiment of the present invention, it is provided that fuzzy top event Xₖ is predefined within the scope of a design of the technical system, for example based on so-called requirements. Requirements generally specify requirements for the reliability of the technical system.

According to one specific embodiment of the preset invention, it is provided that fuzzy top event Xₖ is represented by a (1×m) vector, where m is the number of elements of the fuzzy membership function, and/or fuzzy fault tree topology Aₖᵢ is represented by a (1×(n²−n)/2) vector, where n is the number of base events, and/or fuzzy membership function matrix W is represented by an ((n²−n)/2×m) matrix.

According to one specific embodiment of the present invention, it is provided that fuzzy fault tree topology Aₖᵢ represents linkages between base events via logical AND operators and/or OR operators. The AND operators and/or OR operators are fuzzy operators and are based on fuzzy equations. The AND operators and/or OR operators are programmable.

According to one specific embodiment of the present invention, it is provided that the steps of the iterative process are repeated as long as an abort criterion is not yet reached.

According to one specific embodiment of the present invention, it is provided that an abort criterion is provided by reaching or exceeding a certain number of iterations. The number of iterations may advantageously be predefined arbitrarily. For a use of the method that is not time-critical, in particular in the development of the technical system, for example a greater number of iterations may be run through. For a time-critical use of the method, in particular during operation of the technical system, a smaller number of iterations may be run through.

According to one specific embodiment of the present invention, it is provided that an abort criterion is provided by reaching or falling below a certain value of the difference, in particular the metric distance, between fuzzy membership function matrix Wᵢ^{λ} and fuzzy membership function matrix Wᵢ^{λ+1}, in particular for each element of fuzzy membership function matrix Wᵢ^{λ} and fuzzy membership function matrix Wᵢ^{λ+1}. The difference between one fuzzy membership function matrix and the next becomes smaller with increasing iteration.

Further specific embodiments of the present invention relate to a computer program, the computer program including computer-readable instructions, and a method according to the specific embodiments being carried out when the instructions are executed by a computer.

Further specific embodiments of the present invention relate to a device for testing a technical system in real time, in particular software, hardware, or an embedded system, the device being designed to carry out a method according to the specific embodiments.

According to one specific embodiment of the present invention, it is provided that the device is a control unit of the technical system and is designed as an embedded real-time microcontroller application for carrying out the method according to the specific embodiments.

The iterative algorithm of the example method advantageously requires comparatively little computing time, so that an embedded real-time microcontroller application is thus made possible.

A computer-implemented method and/or a computer program and/or a device according to the specific embodiments of the present invention may advantageously be used even during the development of technical systems, in particular in the automotive field, in particular in the field of autonomous driving, or for testing and/or monitoring the technical systems, in particular when the technical systems are used. A technical system is understood to mean, for example, hardware, in particular a control unit, a computer program, or an embedded system. The technical system is tested or monitored, in particular based on measurements during operation or based on simulations prior to the initial start-up, and analyzed for the likelihood of failure or for product safety. Components of the technical system are represented by base events. Priorities may be determined for these base events, based on the method. Based on the priorities, it may be determined in real time which components are the critical components for safety or risk of failure of the technical system. Based on the ascertained priorities, the technical system may advantageously be adapted or designed, in particular automatically, in order to reduce a likelihood of failure or to increase product safety.

Further features, application options, and advantages of the present invention result from the following description of exemplary embodiments of the present invention illustrated in the figures of the drawing. All described or illustrated features, alone or in any arbitrary combination, constitute the subject matter of the present invention, regardless of their wording or illustration in the description or figures, respectively.

### BRIEF DESCRIPTION OF THE DRAWINGS

FIG. 1 shows a schematic illustration of steps of a method according to one specific embodiment of the present invention in a flowchart.

FIG. 2 shows a schematic illustration of a fuzzy fault tree topology of a technical system, in accordance with an example embodiment of the present invention.

FIG. 3 shows a schematic illustration of a device according to one specific embodiment of the present invention in a block diagram.

### DETAILED DESCRIPTION OF EXAMPLE EMBODIMENTS

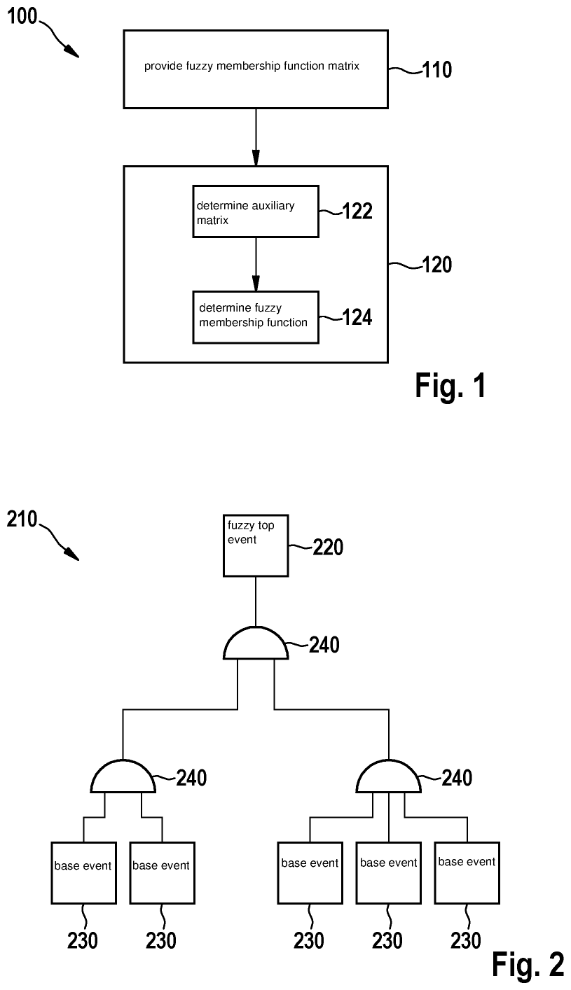

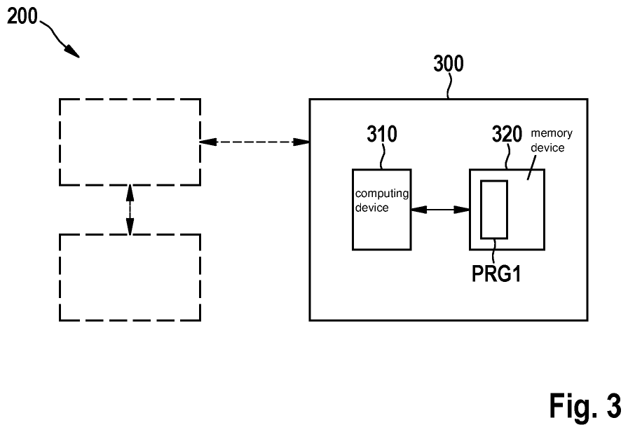

FIG. 1 shows a schematic illustration of steps of a method 100 in a flowchart. Method 100 is a method for testing a technical system 200 (cf. FIG. 3), in particular software, hardware, or an embedded system, in real time.

Technical system 200 includes a plurality of in particular technical components. A schematic illustration of a fuzzy fault tree topology 210 is shown in FIG. 2.

A fuzzy top event 220 is situated at the top of fuzzy fault tree topology 210. Fuzzy top event 220 represents an undesirable event, for example the total failure of the technical system.

Fuzzy top event 220 is ascertained within the scope of a hazard analysis, for example, and predefined by so-called requirements which describe the requirements for the reliability of technical system 200.

According to FIG. 1, five base events 230 are illustrated by way of example. Linkages between base events 230 are represented by logical AND operators and/or OR operators 240.

In method 100, technical system 200 as fuzzy fault tree topology Aₖᵢ is represented by a (1×(n²−n)/2) vector, where n is the number of base events. Fuzzy top event 220 as fuzzy top event Xₖ is represented by a (1×m) vector, where m is the number of elements of the fuzzy membership function of top event Xₖ.

Base events 230 are represented in a fuzzy membership function matrix Wᵢ^{λ} by an ((n²−n)/2×m) matrix.

The membership functions are provided in particular as triangular or trapezoidal membership functions.

Starting from fuzzy top event Xₖ, the following steps are carried out according to method 100 for determining priorities of base events:

providing 110 a fuzzy membership function matrix Wᵢ^{λ} of the base events, where λ=1, and
carrying out 120 an iterative process, each iteration λ, where λ=1, 2, 3, . . . , n, encompassing the following steps:
determining 122 an auxiliary matrix Cₖᵢ, taking into account fuzzy top event Xₖ, fuzzy fault tree topology Aₖᵢ, and fuzzy membership function matrix Wᵢ^{λ}, using an iterative algorithm, and determining 124 fuzzy membership function matrix Wᵢ^{λ+1} based on auxiliary matrix Cₖᵢ, using a maximum likelihood method.

Auxiliary matrix Cₖᵢ is iteratively determined via the following equation:

$${C}_{ki} = \frac{{W}_{i}^{λ} {X}_{k} {A}_{ki}}{{r}_{k}}$$

where i=1, 2, . . . n,
where

$${r}_{k} = {\sum }_{i = k}^{n} {A}_{ki} {W}_{i}^{λ}$$

applies and Wᵢ^{λ} represents the instantaneous estimate of the fuzzy membership functions, Xₖ represents the fuzzy top event, and Aₖᵢ represents the fuzzy fault tree topology.

In the iterative process, fuzzy membership function matrix Wᵢ^{λ+1} is iteratively determined via

$${W}_{i}^{λ + 1} = \frac{1}{{q}_{i}} {\sum }_{k = 1}^{i} {c}_{ki} ,$$

where the following applies:

$${q}_{i} = {\sum }_{k = 1}^{i} {A}_{ki} .$$

The priority of the base events is derived from the difference between the elements of fuzzy membership function matrix Wᵢ¹ and the elements of fuzzy membership function matrix Wᵢ^{λ+1}. Iteration λ+1 is advantageously the last iteration of the iterative process. Thus, fuzzy membership function matrix Wᵢ^{λ+1} is the last matrix computed using the iterative process. Fuzzy membership function matrix Wᵢ^{λ+1} is then compared to original fuzzy membership function matrix Wᵢ¹, and the priority of the base events is derived based on the difference between the two matrices. For the two matrices, namely, fuzzy membership function matrix Wᵢ¹ and fuzzy membership function matrix Wᵢ^{λ+1}, the metric distance between the lines is advantageously compared for each line. The base event with the greatest difference is advantageously the base event having the highest priority. The base event with the smallest difference is advantageously the base event having the lowest priority. For the components of the technical system, via the priorities of the base events an analysis may be made concerning to what extent the component is important or critical for the safety or the risk of failure of the technical system. Based on the analysis, the technical system may advantageously be adapted to reduce the likelihood of failure or to increase product safety. The method may be used even during the development of technical systems, in particular for designing the components. In addition, the method may be used during operation of technical systems. For example, safety-relevant decisions may then be made as a function of the ascertained priorities.

According to one specific embodiment of the present invention, it is provided that the provision of fuzzy membership function matrix Wᵢ^{λ}, where λ=1, takes place by assigning instantaneous values, in particular states and/or measuring results of the technical system. The technical system is, for example, a technical system of a vehicle. Values and/or measuring results are, for example, sensor values and/or values or states of components of the technical system. For example, in particular temperature-dependent sensitivities or time-dependent likelihoods of failure of components may be involved.

According to one specific embodiment of the present invention, it is provided that after a time period elapses, a fuzzy membership function matrix Wᵢ^{λ} of the base events, where λ=1, is again provided, and the iterative process is carried out again based on instantaneous fuzzy membership function matrix Wᵢ^{λ} of the base events, where λ=1. The new provision of fuzzy membership function matrix Wᵢ^{λ} takes place, for example, by providing a value table encompassing, for example, values and/or states of components of the technical system. The value table includes, for example for a certain time period, values and/or states of the components at various points in time. In addition, the provision of fuzzy membership function matrix Wᵢ^{λ} may also take place by again measuring values and/or states of components of the technical system. For example, it is conceivable for the time period after which a fuzzy membership function matrix Wᵢ^{λ} of the base events, where λ=1, is provided again to be in the range of approximately 1 ms to 10 ms, so that the iterative process is carried out again every 1 ms to 10 ms.

According to one specific embodiment of the present invention, it is provided that the steps of the iterative process are repeated as long as an abort criterion is not yet reached.

According to one specific embodiment of the present invention, it is provided that an abort criterion is provided by reaching or exceeding a certain number of iterations. The number of iterations may advantageously be predefined arbitrarily. For a use of the method that is not time-critical, in particular in the development of the technical system, for example a greater number of iterations may be run through. For a time-critical use of the method, in particular during operation of the technical system, a smaller number of iterations may be run through.

According to one specific embodiment of the present invention, it is provided that an abort criterion is provided by reaching or falling below a certain value of the difference between fuzzy membership function matrix Wᵢ^{λ} and fuzzy membership function matrix Wᵢ^{λ+1}, in particular for each element of fuzzy membership function matrix Wᵢ^{λ} and fuzzy membership function matrix Wᵢ^{λ+1}. The difference between one fuzzy membership function matrix and the next becomes smaller with increasing iteration.

FIG. 3 shows a device 300 for testing technical system 200. Device 300 is designed to carry out method 100 according to the specific embodiments of the present invention.

Device 300 includes a computing device 310 with which a memory device 320, for example, may be associated, in particular for at least temporarily storing at least one computer program and/or data, in particular data to be processed with the aid of computing device 310. It is further preferred that a computer program PRG1 may be stored in memory device 320 for at least temporarily controlling an operation of device 300, in particular for carrying out method 100 according to the specific embodiments of the present invention.

Computing device 310 is a microprocessor, for example. Memory device 320 includes at least one of the following elements: a volatile memory, in particular a working memory (RAM), and a nonvolatile memory, in particular a flash memory.

According to one specific embodiment of the present invention, it is provided that device 300 is a control unit of technical system 200 and is designed as an embedded real-time microcontroller application for carrying out method 100 according to the specific embodiments.

The iterative algorithm of method 100 advantageously requires comparatively little computing time, so that an embedded real-time microcontroller application is thus made possible.

What is claimed is:

1. A computer-implemented method for testing a technical system including software, hardware, or an embedded system, in real time, the technical system including a plurality of technical components, and the technical system being represented by a fuzzy fault tree topology Aₖᵢ where k=1 and i=1, . . . , (n*n−n)/2, and, starting, from a fuzzy top event Xₖ for determining priorities of base events, performing the following steps:
providing a fuzzy membership function matrix Wᵢ^{λ} of the base events, where λ=1; and
carrying out an iterative process, each iteration λ, where λ=1, 2, 3, . . . , n, including the following steps:
determining an auxiliary matrix Cₖᵢ, taking into account the fuzzy top event Xₖ, the fuzzy fault tree topology Aₖᵢ, and the fuzzy membership function matrix Wᵢ^{λ}, using an iterative algorithm, and
determining the fuzzy membership function matrix Wᵢ^{λ+1} based on the auxiliary matrix Cₖᵢ, using a maximum likelihood method.

2. The computer-implemented method as recited in claim 1, wherein a priority of the base events is derived from a difference between elements of the fuzzy membership function matrix Wᵢ¹ and elements of the fuzzy membership function matrix Wᵢ^{λ+1}, the difference being a difference between metric distance of lines of the fuzzy membership function matrix Wᵢ¹ and lines of the fuzzy membership function matrix Wᵢ^{λ+1}.

3. The computer-implemented method in claim 1, wherein the providing of the fuzzy membership function matrix Wᵢ^{λ}, where λ=1, takes place by assigning instantaneous values, the instantaneous values being states and/or measuring results of the technical system.

4. The computer-implemented method as recited in claim 1, wherein after a time period elapses, a fuzzy membership function matrix Wᵢ^{λ} of the base events, where λ=1, is again provided, and the iterative process is carried out again based on the instantaneous fuzzy membership function matrix Wᵢ^{λ} of the base events, where λ=1.

5. The computer-implemented method as recited in claim 1, wherein the auxiliary matrix Cₖᵢ is determined iteratively via the following equation:
$${C}_{ki} = \frac{{W}_{i}^{λ} {X}_{k} {A}_{ki}}{{r}_{k}}$$
where i=1, 2, . . . n,
where
$${r}_{k} = {\sum }_{i = k}^{n} {A}_{ki} {W}_{i}^{λ}$$
applies and Wᵢ^{λ} represents an instantaneous estimate of the fuzzy membership functions, Xₖ represents the top event, and Aₖᵢ represents the fuzzy fault tree topology.

6. The computer-implemented method as recited in claim 1, wherein the fuzzy membership function Wᵢ^{λ+1} is determined via
$${W}_{i}^{λ + 1} = \frac{1}{{q}_{i}} {\sum }_{k = 1}^{i} {c}_{ki} ,$$
where the following applies:
qᵢ=Σₖ₌₁ⁱAₖᵢ.

7. The computer-implemented method as recited in claim 1, wherein the top event Xₖ is predefined within the scope of a design of the technical system, based on requirements.

8. The computer-implemented method as recited in claim 1, wherein the top event Xₖ is represented by a (1×m) vector, where m is a number of elements of the fuzzy membership function, and/or the fuzzy fault tree topology Aₖᵢ is represented by a (1×(n²−n)/2) vector, where n is a number of base events, and/or the fuzzy membership function matrix W is represented by an ((n²−n)/2×m) matrix.

9. The computer-implemented method as recited in claim 1, wherein the fuzzy fault tree topology Aₖᵢ represents linkages between base events via logical, programmable AND operators and/or OR operators.

10. The computer-implemented method as recited in claim 1, wherein the steps of the iterative process are repeated as long as an abort criterion is not yet reached.

11. The computer-implemented method as recited in claim 9, wherein the abort criterion is provided by reaching or exceeding a certain number of iterations.

12. The computer-implemented method as recited in claim 9, wherein the abort criterion is provided by reaching or falling below a certain value of a metric distance, between the fuzzy membership function matrix Wᵢ^{λ} and the fuzzy membership function matrix Wᵢ^{λ+1}, for each element of the fuzzy membership function matrix Wᵢ^{λ} and the fuzzy membership function matrix Wᵢ^{λ+2}.

13. A non-transitory computer-readable storage medium on which is stored a computer program including computer-readable instructions for testing a technical system including software, hardware, or an embedded system, in real time, the technical system including a plurality of technical components, and the technical system being represented by a fuzzy fault tree topology Aₖᵢ where k=1 and i=(n*n−n)/2, and, the computer program, when executed by a computer, causing the computer to perform, starting, from a fuzzy top event Xₖ for determining priorities of base events, the following steps:
providing a fuzzy membership function matrix Wᵢ^{λ} of the base events, where λ=1; and
carrying out an iterative process, each iteration λ, where λ=1, 2, 3, . . . , n, including the following steps:
determining an auxiliary matrix Xₖᵢ, taking into account the fuzzy top event Xₖ, the fuzzy fault tree topology Aₖᵢ, and the fuzzy membership function matrix Wᵢ^{λ}, using an iterative algorithm, and
determining the fuzzy membership function matrix Wᵢ^{λ+1} based on the auxiliary matrix Cₖᵢ, using a maximum likelihood method.

14. A device for testing a technical system in real time, the technical system including software, hardware, or an embedded system, the technical system including a plurality of technical components, and the technical system being represented by a fuzzy fault tree topology Aₖᵢ where k=1 and i=1, . . . , (n*n−n)/2, and, the device configured to, starting, from a fuzzy top event Xₖ for determining priorities of base events:
provide a fuzzy membership function matrix Wᵢ^{λ} of the base events, where λ=1; and
carry out an iterative process, each iteration λ, where λ=1, 2, 3, . . . , n, including:
determination of an auxiliary matrix Cₖᵢ, taking into account the fuzzy top event Xₖ, the fuzzy fault tree topology Aₖᵢ, and the fuzzy membership function matrix Wᵢ^{λ}, using an iterative algorithm, and
determination of the fuzzy membership function matrix Wᵢ^{λ+1} based on the auxiliary matrix Cₖᵢ, using a maximum likelihood method.

15. The device as recited in claim 14, wherein the device is a control unit of the technical system and is configured as an embedded real-time microcontroller application.
